(19) United States
(12) Patent Application Publication
(10) Pub. No.: US 2004/0029075 A1
(43) Pub. Date: Feb. 12, 2004

(54) Implant set and corresponding implants

(76) Inventors: Gabriel Guy Peltier, Rueil Malmaison (FR); Patrick Peltier, Rueil Malmaison (FR)

Correspondence Address: LARSON & TAYLOR, PLC, 1199 NORTH FAIRFAX STREET, SUITE 900, ALEXANDRIA, VA, 22314, US

(21) Appl. No.: 10/380,534

(22) PCT Filed: Sep. 18, 2001
(86) PCT No.: PCT/FR01/02901

(30) Foreign Application Priority Data
Sep. 19, 2000 (FR) 00/11944

(51) Int. Cl. A61C 8/00

(52) U.S. Cl. 433/173; 433/201.1

(57) ABSTRACT

In an arrangement for anchoring a threaded implant (1) in dentine (2) by means of a screwing instrument (6), use is made of an implant which, at its upper part, is provided with an anchoring hole (1c) for a screw (5) intended to secure an element or fixture holder (4) that can be attached to the implant. The centre axis of the anchoring hole is inclined in relation to the longitudinal axis (1b) of the implant. The element is provided with means (4d) for cooperation with the instrument (6). The element and its means of cooperation permit application of the instrument in a way which ensures that the axis of rotation (6d) of the instrument essentially coincides with a continuation of the longitudinaxis (1b) of the implant.

The present invention relates to an improvement to dental implants.

A dental implant conventionally comprises an implant body which generally has an external thread and an internal tapping, for implantation in the bony mandibular or maxillary tissue and a part which is known as a pillar or false stump and is capable of being transfixed on the implant body so as to rise above the implant so that it can receive a dental prosthesis. For appropriate orientation of the prosthesis with good parallelism relative to the natural teeth, it must be possible to orientate the pillar or false stump around the axis of the implant body then to fix it. The same applies to the inclination, which may be obtained either using a variable inclination means or using a set of pillars which are pre-inclined at different angles.

Implants in two assemblable portions are described, for example, in U.S. Pat. No. 5,947,733, DOS 27 43 035, GB-A-2 252 501, EP-A-0 337 759, EP 0 139 052, JP-A-08 252269.

For rotational angular adjustment around the axis of the implant body, it is known to use indexing means such as a polygonal assembly with, for example, 6 or even 12 faces or a serrated assembly on the face of implant and pillar, for example with 24 to 36 teeth. These known indexing means create local reductions in thickness and problems with fitting which are sometimes detrimental to the strength of the assembly, taking into consideration the very high forces that may be applied to the implant.

The document U.S. Pat. No. 3,950,850 describes a set of monobloc implants made of alumina with different angles between the body and the pillar. The implant bodies are produced either in the form of flat bases or in the form of conical bodies of elliptical section to impede rotation. To impede extraction, the elliptical bodies, which possess high conicity, have a succession of annular grooves separated by ridges inscribed in the geometric cone. The implants necessitate the drilling of non-circular orifices and pronounced impaction during fitting, so the installation thereof traumatises the bony tissue without necessarily preventing the risk of extraction, particularly at the outset. Furthermore, bent implants may be inserted only in a single angular position.

U.S. Pat. No. 4,474,556 describes a monobloc rectilinear implant made of ceramic such as alumina of which the implant body has a succession of grooves in the form of undulations of which the rounded crests are tangential with a geometric cone having conicity of between 2.5° and 10°. It is not intended to modify these implants to allow a set of different angles. This implant requires a good bony filling of the grooves to impede extraction.

To avoid the formation of such sets of implants, FR-A-2 759 283 describes a monobloc implant made of zirconia, in which the shape of the implant body is determined by the setting of an impression in the bony cavity scanned in three dimensions to act as a template for the machining of a moulded zirconia lug. This process is very complicated and necessitates the machining of moulded zirconia, which is a particularly difficult operation.

The present invention relates to a set of dental implants comprising a plurality of monobloc implants having a portion forming an implant body and a portion forming a pillar, the various implants in the set having different angles between the axis of the implant body and the axis of the pillar, with circular conical implant bodies having conicity of between 3 and 6°, the implant bodies being adapted to be fixed in the mandibular or maxillary bone by impaction and being provided with anti-upthrust means including an anti-upthrust effect due to the conicity and with anti-rotation means capable of cooperating with the adjacent bone to hold the implant in its position.

Preferably, the angles between the aforementioned axes of the implants of the set range from 0° to 30°, or even to 45°, for example from 5 in 5°.

For example, a set may have seven individual implants with angles of 0°, 5°, 10°, 15°, 20°, 25°, 30°. If the set comprises angles of up to 45°, it may also comprise, for example, implants with 35°, 40° and 45°.

Other variations of angles are obviously possible, for example from 10° in 10°, or values between 5 and 10°, or combinations of these values, for example of 5 in 5° for smaller angles and of 10 in 10° for greater angles.

The implant bodies of the set have a conical appearance with conicity of between 3 and 6°, for example 4 or 5°.

To carry out the corresponding drilling of the bone, the practitioner will use a drill having the same conicity.

The anti-upthrust means comprise the conical surface(s) having the aforementioned conicity.

In particular, they comprise a smooth conical portion located at the upper end of the implant body, beneath the pillar.

This smooth portion preferably has a height of 2 to 3 mm, or even more.

Owing to the circular section conical surface of the implant body having the aforementioned conicity, it is found that the implant resolutely opposes the upthrust, in particular at the beginning of implantation, even without an additional fixing means.

The surface of the implant body may have a plurality of fixing zones forming anti-upthrust means such as portions or zones forming smaller diameter recesses so as to define, in an axial plane, fixing teeth or reliefs allowing colonisation of the bone which also impedes the upthrust of the implant body from the mandibular or maxillary bone.

Small reliefs which are spaced at equal angles and extend radially over a short distance from a smooth conical surface, preferably to the lower portion of the implant body, may also be provided as anti-upthrust means. The short distance is advantageously approximately 0.1 to 0.3 mm. During immersion of the implant into the bone during which the practitioner drives the implant while causing it to perform slight alternate rotations around its axis, these small reliefs end up by opening up their passage by cutting a groove in the bone with a sawtooth course, preventing removal of the implant from the hole.

The small reliefs, which are optionally pointed, are easy to produce by merely moulding the implant if it is moulded from zirconia.

The anti-rotation means of the implant body may advantageously be grooved flattened regions or polygonal surfaces extending over a portion or the entire length of the implant body.

For example, the implant body may have one or more semi-cylindrical or semi-conical grooves, preferably with the same conicity as the body itself, which open at the upper end of the implant body and act as a guide for drilling, after implantation, a cylindrical or conical hole formed by the groove in the body and by the opposite groove obtained in the bony tissue and in which a corresponding cylindrical or conical needle will be immersed to impede rotation of the implant by a key effect.

The implant body may have a conical end with conicity which is the reverse of the general conicity.

A truncated cone shaped portion of greater conicity may be formed at the joint between the implant body and the pillar at the level where the gum is crossed.

The implants according to the invention may be produced from any conventional biocompatible material, in particular from titanium. In a particularly preferred embodiment, however, the implants are produced from zirconia. It is in fact found that the zirconia implants according to the invention lead to very rapid consolidation and osteo-integration so the implant bodies may be produced with a moulded external surface which is not excessively traumatising and allows simple manual immersion which is easy to control without special tools. Impaction may even amount to immersion by a mere manual thrust and slight alternate rotations.

The zirconia implants are preferably moulded without machining.

The practitioner will also be able to mount the dental prosthesis on the pillar more rapidly since the implant, which is integrated more quickly, will allow earlier loading.

Zirconia implants prevent electrically conductive contact with the dental nerve and have a better aesthetic appearance as they are invisible below the wall of the dental prosthesis which is often thin and translucent.

The implants of the set according to the invention have very great strength which, combined with excellent osteo-integration and minimal traumatism during fitting, leads to an exceptionally long service life.

These implants may therefore be miniaturised, for example so as to use a plurality of implants to support a prosthesis replacing a single tooth.

If necessary, the implants may be combined with elastic caps interposed between the bone and the implant body or between the pillar and the prosthesis to restore the resilience to compression characteristic of natural teeth.

The invention also relates to the individual miniaturised or other implants which may belong to a set according to the invention.

In order to select the implant having a pillar with a good angular direction from a set, it is advantageous to provide a set of trial implants made, for example, of moulded rigid plastic or of titanium or zirconium if they have to be sterilised and of which the conical implant body surfaces are adapted to allow easy, non-traumatic extraction. The conical surface of the trial implant body may be completely smooth, for example.

The angles of the implants in the trial set are advantageously distributed similarly to the angles of the implants of the definitive set. They may be identified by engraving the size of the angle on a flat region of the pillar.

The implants of the set according to the invention may be packaged in a sterile fashion. As they are made of zirconia, however, they may easily be sterilised prior to fitting, using sterilisation apparatus conventional to practitioners.

The invention also relates to a drill which is specifically adapted for the fitting of the implants according to the invention.

Finally, the invention also relates to a process and a device for moulding sets of implants according to the invention made of zirconia.

Further advantages and characteristics of the invention will emerge on reading the following description given as a non-limiting example and referring to the accompanying drawings in which:

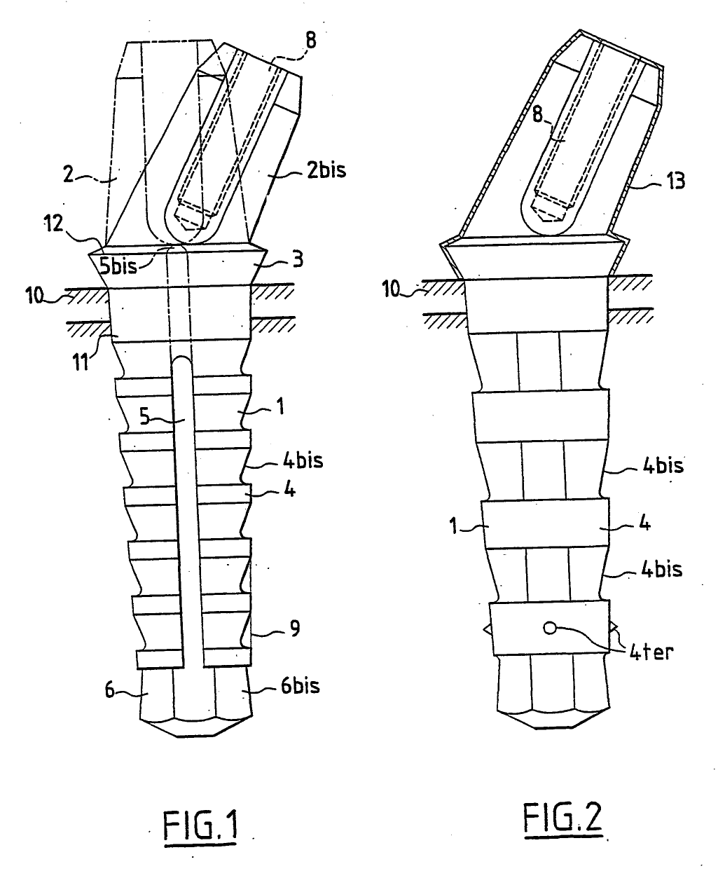

FIG. 1 is an elevation of an implant according to the invention;

FIG. 2 is an elevation of an implant according to a variation of the invention;

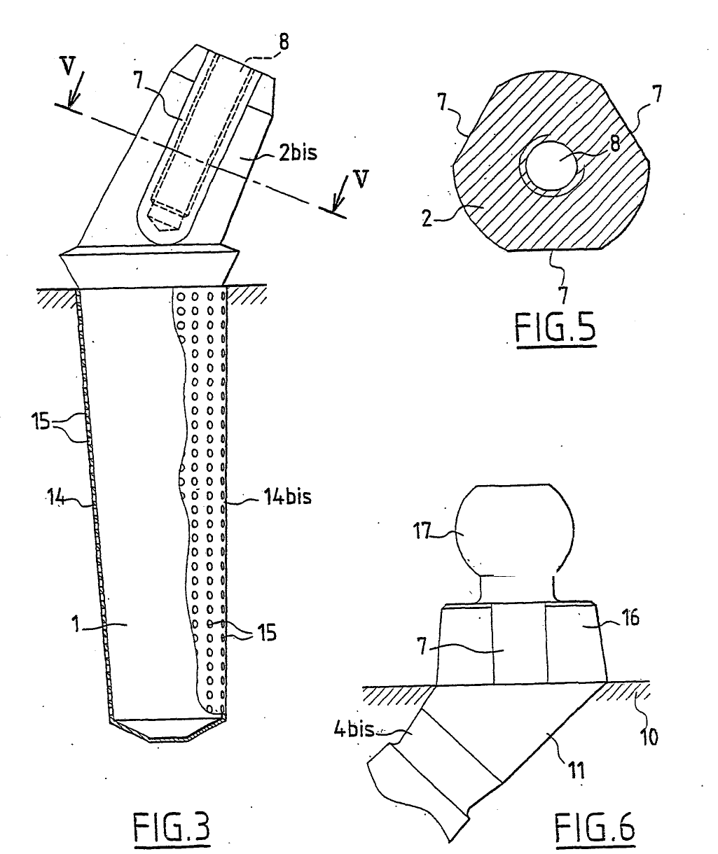

FIG. 3 is an elevation of an implant according to the invention;

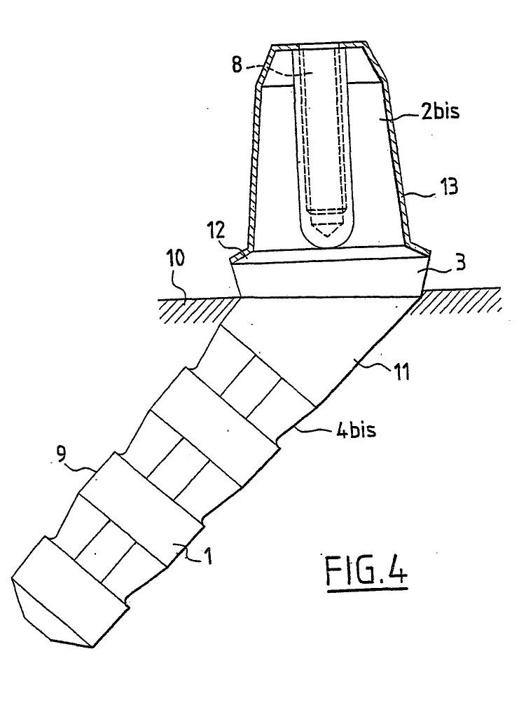

FIG. 4 is an elevation of an implant according to the invention with a very large angle between the body and the pillar;

FIG. 5 is a section of a pillar in a plane perpendicular to its axis;

FIG. 6 is an elevation of an implant with a pillar having a spherical end;

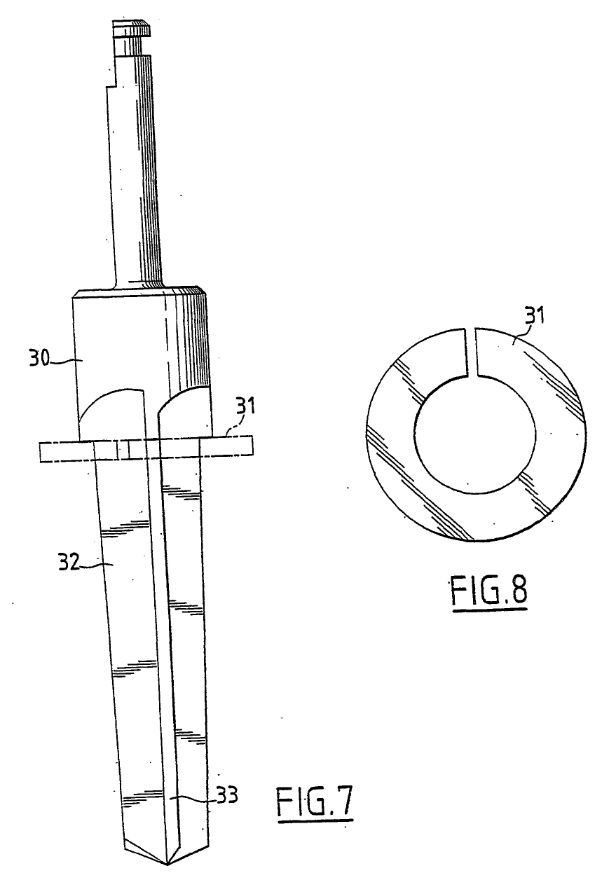

FIG. 7 is an elevation of a drill for the fitting of implants according to the invention;

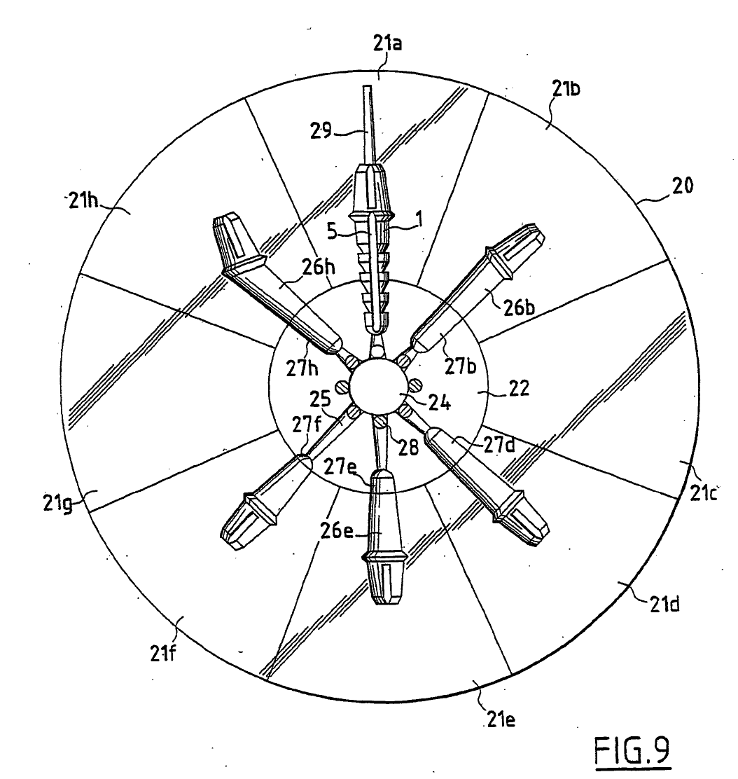

FIG. 8 is a plan view of a ring of this drill;

FIG. 9 is a schematic view of a device for moulding a set of zirconia implants according to the invention.

The monobloc dental implant comprises an implant body 1 made of zirconia, preferably with externally conical overall dimensions 9 determining a conical surface having conicity, for example, of 4 or 5°, optionally subdivided into anti-rejection annular surfaces 4 of which the number is proportional to the immersed depth of the implant. The surfaces 4 form circular ridges surmounted by constrictions forming recesses 4bis which are generated by revolution or are polygonal. The immersed end 5 of the implant 1 is preferably polygonal and conically inverted at 6bis to produce an anti-rejection and anti-rotation effect.

One of the annular conical surfaces, preferably the lower surface, may have short reliefs or lugs 4ter which will be embedded in the bony substance during immersion.

In an axial plane, these anti-rejection means determine shapes of teeth or fixing reliefs which do not impede immersion into the hole made in the bone but impede extraction, particularly if the bone has regenerated itself in the recesses.

Two longitudinal grooves 5 are provided on the conical portion 9 to increase the anti-rotation effect (FIG. 1).

In a particular embodiment, the grooves 5 may be extended over the entire length of the implant body, as shown in mixed lines, to form a groove of which the cross-section is semi-circular and of which the upper end 5bis is accessible, after implantation of the implant body into the jaw bone. The practitioner may therefore drill the portion of the bone opposite the groove with a small drill having a diameter which is slightly smaller than that of the groove cross-section and will be guided in the groove during drilling to define a cylindrical hole of which one half is formed by the groove and the other by the bone. The practitioner may then insert a small cylindrical needle made, for example, of zirconia, into this hole to act as a key and prevent rotation of the implant. The emerging portion of the needle/key will then be cut and ground using a small diamond-tipped drill to match the emerging surface of the implant.

Instead of being semi-cylindrical, the groove 5 may be slightly conical, preferably with the same conicity of 3 to 6° as the implant body. In this case, a thin drill of corresponding conicity will be used to complete the passage in the bone, which is intended to receive a needle having the same conicity.

The length of these needles, once implanted, may be equal to or smaller than the length of the implant body. It may be, for example, from 4 to 10 mm in the case of a diameter of 0.5 to 3 mm and optionally a conicity of 3 to 6°.

The immersed implant 1 comprises a smooth conical portion 11 of 2 to 3 mm which forms part of the cone 9 and comes to the level of the bone 10 and, once the depth of drilling has been modified using a drill having the same conicity as the implant 1, this allows the implant 1 to be immersed to a lesser extent, depending on the thickness of the gum, so that the edge of the large diameter of the portion 3 coincides with the edge of the gum.

This conical portion 11, owing to the selected conicity of between 3 and 6°, preferably 4 or 5°, results in anti-removal contact with the cortical zone of the bone in which it is immersed.

The conical portion 3 known as the gingival portion and emerging from the bone 10 comprises a second conical face 12 on which the prosthesis will rest.

An optional resilient cap 13 having a thickness of 0.1 to 0.5 mm and made of silicone-or another flexible material which is neutral and insusceptible to deterioration and is accepted by the human body may be interposed between, on the one hand, the pillar 2 or 2bis (FIGS. 2, 4) and the prosthesis supporting the tooth. A similar cap 14 may be interposed between the tender bone and the implant 4. These caps may act as a cushion. These caps are obtained by moulding and adjust themselves perfectly to each diameter and shape of the straight or inclined pillar and of the implant 1.

The pillars 2 and 2bis comprise three flat regions 7 at 120° on their conical surface and having a depth of 0.15 to 0.30 mm (FIG. 5). These three flat regions are adjusted using the special spanner which has the function of immersing and orientating the implant. They are also provided to prevent possible rotation of the prosthesis.

In the axis of the pillars 2 and 2bis, a central tapped hole 8 may be provided to receive a transfixing screw on which a little cement will have been placed beforehand for fixing a dental prosthesis such as a dent or a bridge. This tapped central hole 8 is obtained when moulding the implant in the case of ceramic zirconia with a threaded insert which is inserted into the mould prior to injection and may be unscrewed after moulding. This insert may be reused numerous times. It may be made of hardened steel or carbide. This fixing by transfixation with a screw is optional. Some practitioners fix the prosthesis, by sealing, with resinous cement directly on the pillars.

In view of the absence of hollow portions in the implant body 1 and the monobloc continuity between the implant body 1 and the pillar 2 or 2bis, the great strength of the monobloc kit can be perfectly appreciated and can be used to produce implants with quite small diameters of, in other words, 2.5 or even 2 mm which can be combined in twos or threes for a single tooth (the diameters are, for example, from 2 to 8 mm).

If the prosthesis happens to move, it can be re-fixed merely by re-sealing it either with cement or with the transfixing screws, optionally after replacing the elastic cap acting as a cushion.

The cap 14 is made of flexible material, for example of silicone, such as that employed as a casing in mammary prostheses or another plastic material accepted by the human body.

A set of implants according to the invention comprises a plurality of implants such as those just described which have different angles between the axis of the pillar 2, 2bis and of the implant body 1. For example, FIG. 1 shows an implant in which the angle between the two axes is 30°. The case of a pillar 2 for an angle of zero (see also FIG. 4) has been shown in broken lines in this figure. In the case of FIG. 4, the angle is very large as it is 45°.

FIG. 6 shows an implant similar to that in FIG. 1 with a pillar 16 having flat regions as shown in FIG. 5 and ending with a spherical portion 17 having a diameter of between 2 and 4 mm and adapted to receive a complementary fixing means, for example an elastic clip inserted in a removable dental apparatus.

To fix an implant according to the invention, the practitioner drills into the bone with a drill having the same conicity as the implants of the set. If necessary, he seeks the appropriate implant in the set using a set of trial implants having practically the same external conical dimensions as the implant body. He checks which trial prosthesis gives good parallelism between the pillar and the adjacent dental structures and consequently selects the implant having a good angle. After removing the trial prosthesis, he introduces the definitive implant by immersing it into the conical hole, preferably using a spanner or a special tool which will temporarily cap the pillar and is rotationally engaged owing to the flat regions 7 on the conical external surface thereof. Impaction may even be gentle and may not necessarily require an impacting tool, in which case the practitioner merely immerses the implant vigorously in the hole, if necessary with slight to-and-fro rotational movements, the anti-rejection and anti-rotation means such as 1, 6, 4, 4bis then ensuring perfect immobility of the prosthesis in the definitive position.

The prosthesis may be fitted on the pillar after a reduced period.

The invention also relates to a kit comprising the implants of the set, an impaction tool cooperating with the pillars and optionally a set of trial implants.

Reference will now be made to FIGS. 7 and 8.

The implant 1 is accommodated in the bone using conical drills 30 having the same conicity as the implant 1.

Each drill 30 corresponds to the diameter and length of the implant 1 selected by the practitioner.

These drills 30 known as borers/reamers have a special cut for carrying out the actual precise drilling at a low speed of rotation.

The depth of drilling may be modified in order to immerse the implant 1 to a greater or lesser extent into the bone; slit washers 31 are accordingly slipped over the drill 30 beneath its head made, for example, of plastics material such as Delrin; the thickness thereof is preferably between 0.5 and 1 mm.

Three to four washers 31, at most, are sufficient to vary the depth, allowing the implant 1 to be raised to a greater or lesser extent.

These drills 30 preferably comprise three to five cutting lips 33 extending in a radial plane of the axis, and this enables drilling to be carried out without vibrations, guaranteeing good geometry and a good surface state in the cortical substance of the bone.

The drilled apertures 32 enable the lips 33 to perfectly cut and hold the chips of bone. This bony paste, mixed with blood, could be held in these drilled apertures 32 and be reintroduced in part into the drilling in order to fill the voids of the implant, and this would lead to faster osteo-integration of the implant 1 and will allow direct use, in other words immediate fitting of the dental prosthesis on the pillar.

Reference will now be made to FIG. 9.

In the preferred embodiment of the invention, the zirconia implant is not produced by machining as a titanium implant would be but by high-pressure moulding of sintered zirconia.

Advantageously, a plurality of implants, for example the six or eight implants of a set of implants according to the invention, may be moulded in one go using a multiple mould, one half of which is shown in FIG. 9.

This multiple mould comprises a plurality of sectors of a circle, a plan view of the sectors 21a to 21h of the lower half-mould being shown. Each sector comprises a half impression for the pillar and an upper portion of the implant body disposed in a radial direction. It will therefore be appreciated that each of the sectors 21a to 21h will be covered by an associated sector which is symmetrical about the plane of the figure and comprises the symmetrical half impression so as to produce the complete impression, demoulding being carried out by separating the two assemblies of sectors in a direction perpendicular to the plane of the figure, the apparent faces of the sectors forming a part of the joint plane. The various sectors 21a to 21h are separable and, for injection moulding, are connected in the position shown in the figure by any connecting means. When the other multiple half-mould is applied to the half-mould shown in FIG. 9, means for connecting the two half-moulds are also provided in a conventional manner to resist the injection pressure.

The figure shows that the sectors 21a, 21b and 21h correspond to three implants of a set having the same diameter and the same length of implant body (for the sake of simplicity, the impressions have been drawn schematically without showing the surfaces corresponding to the reliefs or depressions such as 4bis, 5, 6bis). Implant 1 as presented after demoulding by resting in the half impression is shown on the sector 21a. The sector 21a and the corresponding sector of the other half-mould superimposed thereon define the impression of an implant in which the angle between the body and the pillar is 0°. The sector 21b defines an implant of the same size with an angle of 5°. The sector 21h defines an implant with an angle of 35°. It will be appreciated that the other sectors may comprise impressions in the case of implants having pillar/body angles which are intermediate between those shown at 21a, 21b and 21h.

For the sake of simplicity, the half-impressions of the sector 21c and 21g have not been shown. The sectors 21d, 21e and 21f comprise impressions identical to those of the impression 21a.

The various sectors are grouped in a circle around a cylindrical half-core 22 which comprises, opposite each sector, half-impressions for the lower part of the implant body. In the illustrated combination, the circular juxtaposition of the various sectors around the half-core 22 therefore determines a plurality of complete radial half-impressions, the kit being completed by the other symmetrical half-mould, which also comprises a symmetrical half-core, when it is juxtaposed on the half-mould shown in the drawing. The portions of half-impressions such as 27b and 27h are connected to a central chamber 24 by the same number of radial channels 25, these radial channels being capable of being blocked by removable injection plugs 28. It will therefore be appreciated that, when the entire mould is assembled, the fluid zirconia preparation under pressure merely has to be introduced into the volume consisting of the superimposition of the two chambers 24 in such a way that the zirconia passing through those channels from which the plug 28 has previously been removed will fill the impressions formed by the superimposition of the two half-impressions of the sectors which cooperate to produce the same impression.

Demoulding is carried out by separating the two half-moulds then by merely extracting the moulded implants 1.

The figure shows that the portions of half-impressions 27d to 27f have different lengths, allowing production of implants having the same diameter but having a length which is different in each case.

It is generally preferred that the cylindrical half-core 22 and the complementary symmetrical half-core have portions of impressions 27a to 27h which are all identical and therefore correspond to a type of implant of a set having the same length and the same diameter. In this case, the various portions of impressions of the sectors correspond to this implant diameter dimension, each sector corresponding, for example, to a pillar having a different inclination. Therefore, the eight implants of a set of implants of the same length and the same diameter but all having body/pillar angles according to the invention may be moulded in one go. However, if some implants in the set are used more frequently than others, for example those having an angle of zero or a small angle, a plurality of sectors having absolutely identical half-impressions may also be used to mould a set comprising identical implants and others having a different angle. Owing to the plugs 28, it is possible to mould only the implants which are required more frequently.

Finally, it will therefore be appreciated that sectors having identical portions of impressions or, on the other hand, different portions of impressions may be juxtaposed and that cores having identical impressions or, on the contrary, different impressions, in particular in length, may be used. The simplest solution is to have cores of which all the impressions are identical, each core corresponding to a predetermined length of implants, different from the length of another core.

However, all the other combinations are possible and allow very precise adaptation to the instantaneous requirement for implants which may be made by clients.

In an improvement in which the implant has one or more cylindrical or conical grooves 5 opening at the upper end of the body, the impression may preferably have, at the upper end and in the axis of the pillar, an extension allowing a key needle 29 which may be separated from the implant by breaking it at its base, to be moulded in one go.

1. Set of dental implants comprising a plurality of monobloc implants having a portion forming an implant body (1) and a portion forming a pillar (2, 2bis), the various implants in the set having different angles between the axis of the implant body and the axis of the pillar, with circular conical implant bodies having conicity of between 3 and 6°, in particular 3°, the implant bodies being adapted to be fixed in the mandibular or maxillary bone by impaction and being provided with anti-upthrust means (4, 6) including the anti-upthrust effect due to the conicity and with anti-rotation means (4bis, 5) capable of cooperating with the adjacent bone to hold the implant in its position.

2. Set according to claim 1, characterised in that it is made of moulded zirconia.

3. Set according to any of claims 1 or 2, characterised in that the conicity is 4 or 5°.

4. Set according to any of claims 1 to 3, characterised in that the implant body has a smooth conical portion located at the upper end of the implant neck, beneath the pillar.

5. Set according to claim 4, characterised in that this smooth portion has a height of 2 to 3 mm.

6. Set according to any of claims 1 to 5, characterised in that it comprises, in the smooth conical surface of the implant body, a plurality of fixing zones forming smaller-diameter recesses.

7. Set according to any of claims 1 to 6, characterised in that it has, as anti-upthrust means, small spaced reliefs spaced at equal angles (4ter) which extend radially over a short distance from a smooth conical surface, in particular to the lower portion of the implant.

8. Set according to claim 7, characterised in that said short distance is approximately 0.1 to 0.3 mm.

9. Set according to any of claims 1 to 8, characterised in that the angles of the set range between 0 and 45°.

10. Set according to any of claims 1 to 9, characterised in that the angles range between 0 and 30°.

11. Set according to any of claims 1 to 10, characterised in that the angles of the set vary by differences of between 5 and 10°.

12. Set according to any of claims 1 to 11, characterised in that the implant body (1) has, toward its upper portion forming a transition with the pillar (2, 2bis), a conical enlargement (3) intended to be located at the level where the gum is crossed.

13. Set according to any of claims 1 to 12, characterised in that the pillar comprises flattened regions (7) allowing, in particular, cooperation with a spanner for insertion of the implant.

14. Set according to any of claims 1 to 13, characterised in that the pillar comprises a screw-threaded orifice for transfixing a prosthesis on the pillar.

15. Set according to any of claims 1 to 14, characterised in that the anti-rotation means are formed by flattened regions or grooves or polygonal surfaces (5, 4bis).

16. Set according to claim 15, characterised in that the groove (5) has a semi-circular, cylindrical or conical section and in that its end (5bis) opens at the surface of the implanted portion so as to allow the passage of a thin drill intended to drill the opposing bony portion to form a cylindrical or conical passage in which there may be introduced a cylindrical or conical needle (29) acting as an anti-rotation key.

17. Set according to any of claims 1 to 16, characterised in that the implant bodies have an end (6, 6bis) with reverse conicity.

18. Set according to any of claims 1 to 17, characterised in that the implants have a miniaturised diameter of approximately 2 mm.

19. Set of test implants, characterised in that it comprises a plurality of implants having the same bulk and the same angles between the body and pillar axes as the implants of the set according to any of claims 1 to 18.

20. Monobloc dental implant having the characteristics of an implant as defined in any of claims 1 to 18.

21. Dental drill for drilling a hole intended to receive an implant according to any of claims 1 to 18 and 20, characterised in that it has conicity between 3 and 6°, identical to the conicity of the implant, and a plurality of cutting lips (33) extending in a radial plane of the drill axis.

22. Drill according to claim 21, characterised in that it has at least three lips (33).

23. Drill according to any of claims 21 or 22, characterised in that it may receive one or more split washers (31) to vary the depth of immersion.

24. Mould for producing drills of a set according to any of claims 1 to 19, characterised in that it comprises two half-moulds which are assembled face to face on a joint plane, each of the half-moulds comprising a plurality of separable sectors having a half impression of an implant portion, said sectors being disposed round a separable central half-core (22) having, in alignment with each sector half-impression, a lower end implant half-impression in continuation with the half-impression of the sector concerned.

25. Mould according to claim 24, characterised in that each half-core (22) has a central inlet passage (24) for material to be injected under pressure, from which there extend radial passages (25) ending at the end of each core half-impression.

26. Mould according to any of claims 24 and 25, characterised in that it comprises individual blocking means (28) for the inlet channels.

27. Mould according to any of claims 24 to 26, characterised in that at least some sectors have a half-impression having a different angle between the implant pillar axis and the implant body axis.

28. Mould according to any of claims 24 to 27, characterised in that the implant impression is extending by a needle impression (29).

29. Assembly of moulds according to any of claims 24 to 28, characterised in that it comprises a plurality of pairs of interchangeable half-cores (22) having diameters and/depths of the ends of impressions which differ from one core to another, and a plurality of sets of sectors having a half impression of which the diameter invariably corresponds to the diameter of the half-impressions of a half-core.
